(19) United States
(12) Patent Application Publication
(10) Pub. No.: US 2009/0169851 A1
(43) Pub. Date: Jul. 2, 2009

(54) PEELABLE SEALABLE PLA FILM

(75) Inventors: Detlef Busch, Saarlouis (DE); Dominic Klein, Neunkirchen (DE); Bertram Schmitz, Sarreguemines (FR)

Correspondence Address: CONNOLLY BOVE LODGE & HUTZ, LLP, P O BOX 2207, WILMINGTON, DE, 19899, US

(73) Assignee: Treofan Germany GmbH & Co., KG, Neunkirchen (DE)

(21) Appl. No.: 12/295,131

(22) PCT Filed: Mar. 9, 2007
(86) PCT No.: PCT/EP2007/052221

§ 371 Date: Sep. 29, 2008

(30) Foreign Application Priority Data
Mar. 31, 2006 (DE) 10 2006 014 974.2

(51) Int. Cl. B32B 27/28

(52) U.S. Cl. 428/220

(57) ABSTRACT

The invention relates to a multilayer biodegradable film produced from a base layer and at least one cover layer, which has a reduced seam strength and which can be used as a cover film for containers. Containers that are sealed with the film according to the invention can be opened more easily than those sealed with conventional film.

The present invention concerns a peelable, biaxially-oriented film, made of a base layer and at least one peelable top layer. The invention further concerns a method for the manufacture of the film, as well as its use.

Films made of thermoplastic plastics are put to use on a large scale for packaging of foods and other packaged goods. Newer developments in the packaging sector concern films made of biodegradable polyesters, like e.g. polylactic acid (PLA). These kinds of films are taken to be particularly environmentally friendly, as they are based on renewable raw materials and can be disposed of by composting. However, these materials are fundamentally different to the olefinic polymers like polyethylene or polypropylene which are introduced on a large scale for packaging films. The transfer of the technical teachings from polyester films also often does not succeed, as the same or similar measures often do not have the desired effect in PLA films.

The success of packaging films made of thermoplastic polymers rests on good optical and mechanical properties as well as on the simple weldability or sealability of the films. Sealable polyolefinic films generally possess a top layer made of an olefinic polymer, which has a lower crystallite melting point than the polymers of the base layer of the film. PLA films generally have a seal layer made of amorphous, non-crystallizable PLA polymers on a base layer made of partially crystalline PLA. For sealing, the films are laid on top of each other and heated to 10 to 20° C. under the crystallite melting point, or 20-40° C. over the glass transition temperature of the PLA polymer, i.e. the top layers are not completely melted on. The adherence of the sealed layers achieved should come to at least 1.5-2 N/15 mm, in order to ensure a sufficient sealed seam strength.

The sealed seams in many cases have a higher mechanical strength then the films themselves, so that upon opening a sealed film package the package is not only torn open and destroyed along the seam, but rather the tear goes into the film itself and then proceeds uncontrolled. This kind of an opening of the seam is called a cohesion fracture. For this reason, in polyolefin films so-called peelable top layers are also applied to the film surface instead of sealable raw materials. The peelable top layers offer good sealing properties on the one hand, but also the possibility of opening the seal seam in a controlled fashion again without destroying the sealed materials.

Such polyolefinic, peelable top layers seal not only against themselves and against conventional sealable top layers, for example made of propylene copolymers and/or terpolymers, but also very well against surfaces made of propylene homopolymers. It is thereby possible to use these films as lid fasteners for containers made of propylene homopolymers and so also to offer single substance packagings made of polypropylenes in containers with a lid catches like e.g. yogurt pots etc.

This kind of properties profile is also designed for PLA films in order to simultaneously introduce the PLA film in such peel uses and to harness the advantages of the biodegradability in this segment as well. Sealable PLA films generally have very high sealed seam strength, for example 6-7 N/15 mm, through which a controlled opening of a packaging in the sealed seam direction is comparably even harder than with the polyolefinic sealing films which are conventionally located with a copolymer or terpolymer sealing layer in a range from 2.5-3.5 N/15 mm. For this reason, the previously mentioned cohesion fracture arises even more often in PLA films, as does an uncontrolled tearing open of the packaging. A modification of PLA films is therefore absolutely required if these are to be put to use as peeling films. It should thereby be kept in mind that a modification for setting the peeling properties may not adversely affect the advantageous biodegradability. Of course, the good optical properties, like high transparency and shine, and a good processing behaviour as well as mechanical properties should all also be retained.

The object of the present invention consisted in producing films for environmentally-friendly packagings and other uses, films which can be manufactured from renewable raw materials like e.g. PLA, can be disposed of in an environmentally-friendly fashion and have good peeling properties. Good processing behaviour as well as good mechanical properties are also required in certain areas of use, in addition to good transparency and high shine values.

The object is achieved by a multilayer, biaxially-oriented film made of a PLA base layer and at least one PLA top layer A, which has a thickness of at least 3 μm and wherein the film has a sealed seam strength of 1-7 N/15 mm after sealing top layer A against itself at a temperature in the range from 85-120° C., and wherein this sealing is carried out under a sealing pressure of 10 N/cm² and a sealing time of 500 ms.

It was found that for use as a peeling film, a thick PLA top layer of at least 2.5 μm is essential to the invention in order guarantee a sufficient tightness of the sealing seam when attaching the sealing film to containers. In the case of too small sealing layers of under 2.5 μm, not all irregularities at the edge of the seal could be evened out, so that the sealing layer did not have enough contact with the edge of the container in all areas of the sealing seam. These defects lead to leakages and a worsened adhesion of the packaged good. It was found that PLA films with a thick sealing layer of >3 μm have a good peelability if a sealing seam strength of 1-7 N/15 mm, preferably of 1-5 N/15 mm, can be achieved within the temperature range of 85-120° C. In this way a sufficient strength of the sealing seam on and the one hand, and simultaneously a controlled separation of the sealed layers, is possible. Surprisingly, these kinds of sealing properties can be set on a film with PLA top layers, even though thick top layers made of amorphous PLA polymers have substantially higher sealing seam strengths, which make controlled peeling impossible. These kinds of high sealing seam strengths in thick top layers complicate the opening of the sealing seam in such a way that too high strengths are required and the packaging must be opened by the user with another tool which actually should not be necessary. Cases arise where the attempt at peeling with brute force leads to tearing of the covering film itself so that no controlled detaching of the film on the piece is possible. Top layers made of crystalline PLA, on the other hand, do not seal in the named temperature range at all, i.e. the sealing seam strength in the whole range between 85 and 130° C. lies under 0.5 N/15 mm.

The sealable and peelable top layer of the film according to the invention is generally made up of a mixture of at least two different polymers A and B, wherein polymer A is a biodegradable polymer made of at least one aliphatic hydroxycarboxylic acid and polymer B is a biodegradable Polymer different to polymer A.

The peelable top layer contains 80 to <100% by weight, preferably 85 to <99% by weight of the polymer mixture from components A and B. By ‘mixture’ in the sense of the present invention, we mean mechanical mixtures or a blend from the components, mechanical mixtures being manufactured from the individual components. In general, for this the individual constituents are poured together as pressed moulds of small sizes, e.g. lens-, ball-, or rod-shaped granulate, and mechanically mixed, A ‘blend’ in the sense of the present invention is an alloy-like composition of the individual components which can no longer be fractionised into the original constituents. A blend has properties like a homogenous substance and can be correspondingly characterised by suitable parameters.

The ratio (weight ratio) of the components A and B of the mixture can vary within wide boundaries. The ratio of the components A and B preferably lies in a range of A:B=30:70 to A:B 80:20, preferably between A:B=40:60 to A:B 70:30, in particular at A:B=50:50.

Component A is an amorphous, aliphatic hydroxycarboxylic acid, subsequently called PHC (polyhydroxycarboxylic acid). By this are to be understood homopolymers or mixed polymerisates which are made up of polymerised units of aliphatic hydroxycarboxylic acids. Of the PHC suitable for the present invention, polylactic acids are particularly suitable. These are subsequently called PLA (polylactic acid). Here too, the term PLA is to be understood as meaning both homopolymers which are made up solely out of lactic acid units, and mixed polymeristaes which predominantly contain lactic acid units (>50%) in compounds with other aliphatic hydroxycarboxylic acids.

Aliphatic mono, di or trihydroxycarboxylic acids are particularly suitable as monomers of the aliphatic polyhydroxycarboxylic acids (PHC), or rather their dimeric cyclic esters, of which lactic acid in its D or L form is preferred. A suitable PLA is e.g. polylactic acid from the Cargill Dow company (NatureWorks®). The manufacture of polylactic acids is known from the prior art and is carried out by catalytic ring opening polymerisation of lactide (1,4-dioxane-3,6-dimethyl2,5-dione), the dimeric cyclic ester of lactic acid, because of which PLA is often called polylactide. The manufacture of PLA is described in the following publications: U.S. Pat. No. 5,208,297, U.S. Pat. No. 5,247,058 or U.S. Pat. No. 5,357,035.

Suitable amorphous polylactic acids contain D and L lactic acid units. In this, PLA polymers which contain 80-98%, preferably 82-95% L lactic acid units are particularly preferred, corresponding to 2 to 20% by weight, preferably 5-18% by weight D lactic acid units. In order to reduce the crystallinity, even higher concentrations of D lactic acid units can be contained as comonomers. If appropriate, the polylactic acid can have various aliphatic polyhydroxycarboxylic acid units, additional to the lactic acid, in the corresponding quantities as comonomers, for example glycolic acid units, 3-hydroxypropanoic acid units, 2,2-dimethyl-3-hydroxypropanoic acid units or higher homologues of the hydroxycarboxylic acids.

Lactic acid polymers (PLA) with a softening range of 60 to 150° C., preferably 65 to 140° C., and a melt flow index (DIN measurement 53 735 at 2.16 N load and 190° C.) of 1 to 50 g/10 min, preferably 1 to 30 g/10 min, are preferred. The molecular weight of the PLA lies in a range from at least 10000 to 500000 (number average), preferably 50000 to 300000 (number average). The glass transition temperature Tg lies in a range from 40 to 100° C., preferably 40 to 80° C. A suitable PLA is e.g. the polylactic acid 4060 D of the Cargill Dow company (NatureWorks®).

Component B is a polymer from the group of the biodegradable polymers. This can thereby concern a carbohydrate (like starch, sugar, cellulose . . . ), biodegradable polyester (e.g. copolyester of aliphatic, cyclic or aromatic diols and dicarboxylic acids like e.g. glycol, butane diol, adipic acid and terephthalic acid) or proteins, or other biodegradable substances which lead to reduction of the sealability of the PHC layer. Likewise it can concern mixtures of two or several of the biodegradable substances.

Suitable, commercially-available substances are e.g. the Ecoflex products of the BASF company or Mater-Bi of the Novamont company. Ecoflex is a biodegradable, static, aliphatic-aromatic copolyester. Mater-Bi is a biodegradable blend which contains starch and biodegradable polyester as its main ingredients.

The ECOFLEX F BX 7011 mentioned in the examples is a copolyester of the monomers 1,4-butane diol, adipic acid and terephthalic acid with a melting range of 110-120° C. (determined by means of DSC) with a melting viscosity of 2.7-4.9 g/10 in (190° C., 2.16 kg).

The Mater-Bi used in the examples mentioned has a softening range of 65-153° C. (determined by means of DSC) with it and a melting viscosity of 10 g/10 min (160° C., 5 kg).

The film according to the invention is multilayer and comprises at least the base layer and at least one peelable top layer. If appropriate, a further top layer can be attached on the opposite side of the film, wherein this second top layer can likewise be peelable or otherwise formulated. Furthermore, it is possible to attach an additional one or two-sided intermediate layer between the base layer and the top layer(s), by which four of five-layered films are obtained.

The base layer, in the sense of the present invention, is the layer which has the largest layer thickness and generally makes up more than 40% to 98%, preferably 50 to 90%, of the total film thickness. The top layers are the layers which form the external layers of the film. Intermediate layers are naturally attached between the base layer and the top layers.

The base layer of the film generally contains at least 70 to <100% by weight, preferably 85 to 99% by weight relative to the weight of the layer, polymers of at least one hydroxycarboxylic acid. For a base layer, suitable polymers are polylactic acids which are built up only out of lactic acid units, and mixed polymerisates, which predominantly contain lactic acid units (>50%) in compounds with other aliphatic hydroxydicarboxylic acids or other dicarboxylic acids.

A crystalline lactic acid polymer (PLA) with a softening range of 100 to 170° C., preferably of 120 to 160° C., and a melt flow index (DIN measurement 53 735 at 2.16 N load and 190° C.) of 1 to 25 g/10 min, preferably of 1 to 15 g/10 min, is used as raw material for the base layer. The molecular weight of the PLA lies in a range from at least 10000 to 500000 (number average), preferably 50000 to 300000 (number average). The glass transition temperature Tg lies in a range from 40 to 100° C., preferably 40 to 80° C. The ratio of D lactic acids to L lactic acids (D:L) thereby lies in a range from <10:90. Suitable PLA types are, for example, the polylactic acid 4032D or 4042D of the Cargill Dow company (NatureWorks®).

Transparent films in the sense of the present invention are those films whose light permeability according to ASTM-D 1003-77 lies over 75%, preferably over 90%. It was found that the peelable top layer does not raise the haze of the film, or only insubstantially.

The base layer as well as the other layers of the film, including the peelable, equipped top layer, can additionally contain conventional additives, like neutralisation agents, stabilisers, lubricants and fillers. They are advantageously added to the polymer, or rather the polymer mixture, just before melting on. Inner lubricants, like e.g. erucic acid amides or glycerine monostearate, are added to help the process.

Basically, white or opaque embodiments of the film can also be provided with the peelable top layer on one or both sides. For these embodiments pigments and/or vacuolating fillers are added to the base layer. TiO₂ is preferred as a pigment and is added in a quantity of up to 10% by weight, preferably 1 to 8% by weight, in each case relative to the base layer. Vacuolating fillers are preferably cycloolefin copolymers, in general in a quantity of 0.5 to 30% by weight relative to the weight of the base layer. Properties for this are described in DE 101 21 150, to which explicit reference is made here.

The total thickness of the film can vary within wide boundaries and is directed towards the intended use. The preferred embodiments of the film according to the invention have total thicknesses of 4 to 200 μm, wherein 8 to 150 μm, in particular 10 to 100 μm are preferred. The thickness of such intermediate layer(s) as are present generally comes to 0.5 to 15 μm independently of one another, wherein intermediate thicknesses of 1 to 10 μm, in particular 1 to 8 μm, are preferred. The thickness of the optional second top layer(s) is chosen independently of the other layers and in each case preferably lies in the range from 0.1 to 5 μm, in particular 0.2 to 3 μm. The given values each refer to an intermediate or top layer. The thickness of the base layer is correspondingly given by the difference of the total thickness of the film and the thickness of the attached top and intermediate layer(s) and can therefore vary within wide boundaries, analogously to the total thickness.

Basically, biaxially-oriented embodiments of the film according to the invention are preferred. The peelable top layer can, however, also be attached to multilayer films which are oriented in only one direction, for example only in the longitudinal or only in the lateral direction, or in no direction at all, i.e. in so-called un-oriented cast films.

The invention furthermore concerns a method for manufacturing the multilayer films according to the invention according to the coextrusion method known in itself, which is described in detail subsequently on the basis of the example of a biaxially-oriented film.

Within the scope of this method, the procedure is that the melt(s) corresponding to the layers of the film are coextruded through a flat die, the multilayer film so obtained is drawn off on one or several roller(s) for hardening, the film is subsequently biaxially stretched (oriented), the biaxially-stretched film is heat set and, if appropriate, corona or flame treated on the surface layer intended for treatment.

The components A aid B of the peelable top layer can thereby be conveyed to the extrusion process both as a prefabricated blend and as a granulate mixture.

The biaxial stretching is generally carried out sequentially. In this, stretching is preferably carried out first in the longitudinal direction (i.e. the machine direction=MD direction) and subsequently in the lateral direction (i.e. at right angles to the machine direction=TD direction). This leads to an orientation of the molecular chains. The stretching in the longitudinal direction is carried preferably carried out with the help of two rollers running at different speeds according to the desired stretch ratio. An appropriate clip frame is generally used for lateral stretching. Further description of the film manufacture takes place on the basis of the example of a flat film extrusion with subsequent sequential stretching.

The melt(s) are pressed through a flat die (sheet die), and the film pressed out is drawn off on one or several outfeed rollers at a temperature of 10 to 60° C., preferably 20 to 40° C., wherein they cool down and harden.

The film so obtained is then stretched longitudinally and laterally to the direction of extrusion. The longitudinal stretching is preferably carried out at a roller temperature of the stretch roller of 40 to 130° C., preferably 50 to 100° C., advantageously with the help of two roller running fast at different speeds according to the desired stretch ratio, and the lateral stretching preferably at a temperature of 50 to 130° C., preferably 60 to 120° C. with the help of a corresponding clip frame. The longitudinal stretch ratios can be varied in the range from 1.5 to 4. In the manufacture of films with a base layer containing vacuolating filler, a higher longitudinal stretch ratio of 2 to 5 is preferred, whereas films with a transparent base layer are preferably stretched in the range from 1.5 to 3.5. The lateral stretch ratios lie in the range from 3 to 10, preferably 4 to 7.

Following on from the stretching of the film is their heat setting (heat treatment), wherein the film is held converging approx. 0.1 to 10 s long at a temperature of 60 to 150° C. (convergence up to 25%). Subsequently, the film is wound up in the conventional manner with a winding unit.

If appropriate, the film can be coated in order to set further properties. Typical coatings are barrier, adhesion-enhancing, slip-improving or dehesive-acting coats. If appropriate, these additional coats can be applied by in-line coating by means of aqueous dispersions before lateral stretching, or off-line. These coatings are applied to the side opposite the peelable top layer.

The following measuring methods were used to characterise the films:

Sealed Seam Strength and Peel Strength

To determine this, two 15 mm-wide film strips were laid on top of each other with the peelable side on the inside, and sealed in a temperature range from 80-110° C. with a sealing time of 0.5 s and a seal pressure of 10 N/cm² (device: Brugger Type NDS, sealing jaw heated on one side). In order to determine the seal seam strength, the peeling layer is sealed against itself at a width of 15 mm like this. In this, unsealed ends are allowed to stand away over the sealing area. These ends are mounted in a device for determining mechanical strength from the Zwich company. The maximum strength required to rip the seal seam to a width of 15 mm is called the seal seam strength or peel force.

Haze:

Haze is determined depending on ASTM-D 1003.

The invention is subsequently explained on the basis of exemplary embodiments.

### EXAMPLE 1

A transparent, three-layered PLA film with a thickness of around 50 μm is manufactured by extrusion and subsequent stepwise orientation in the longitudinal and lateral directions. The base layer consisted nearly of nearly 100% polylactic acid with a melting point of around 160° C. from the NatureWorks company (4042D). The layer additionally contained stabilisers and neutralisation agents in the conventional quantities. The peelable, sealable top layer contained, as component A, 60% by weight amorphous, sealable raw material from the NatureWorks company (4060D) and 40% by weight biodegradable raw material from the Novamount company (Mater-Bi KE 03B).

The manufacturing conditions in the individual procedural steps were:

Extrusion: Temperatures 170-200° C.

Temperature of the outfeed roller: 60° C.

Longitudinal stretching: Temperature: 68° C.

Longitudinal stretch ratio: 2.0

Lateral stretching: Temperature: 88° C.

Lateral stretch ratio (effective): 5.5

Fixing: Temperature: 130° C.

Convergence: 10%

In this way, a biaxially-oriented, transparent film with characteristic shine was obtained. The properties of the film are given in the table. The peelable top layer had a thickness of 3.6 μm, the opposite top layer a thickness of 2 μm, the base layer a corresponding thickness of 44.4 μm.

### EXAMPLE 2

By extrusion and subsequent incremental orientation in the longitudinal and lateral directions, a transparent, three-layer PLA film with a thickness of around 50 μm was manufactured. The base layer consisted of near to 100% polylactic acid with a melting point of around 160° C. from the NatureWorks company (4042D). The layer additionally contained stabilisers and neutralisation agents in the conventional quantities. The peelable, sealable top layer contained 40% amorphous, sealable raw material from the NatureWorks company (4060D) (component A) and 60% by weight biodegradable raw material from the Novamount company (Mater-Bi KE 03B) (component B). The manufacturing conditions in the individual procedural steps were the same as in example 1. In contrast to example 1 the thickness of the sealable top layer now came to 5.5 μm. The conventional layer thicknesses corresponded to example 1.

### EXAMPLE 3

By extrusion and subsequent incremental orientation in the longitudinal and lateral direction a transparent, three-layer PLA film with a thickness of approx. 50 μm was manufactured. The base layer consisted of nearly 100% by weight polylactic acid with a melting point of around 160° C. from the NatureWorks company (4032D). The layer additionally contained stabilisers and neutralisation agents in conventional quantities. The peelable, sealable top layer contained 60% component A, the amorphous, sealable raw material from the NatureWorks company (4060D), and 40% by weight biodegradable raw material from BASE ECOFLEX F BX 7011.

The manufacturing conditions in the individual procedural steps were the same as in example 1, the film had the same layer thicknesses as stated in example 1.

### COMPARATIVE EXAMPLE 1

By extrusion and subsequent incremental orientation in the longitudinal and lateral directions, a transparent, three-layer PLA film with a thickness of around 50 μm was manufactured. The base layer consisted of nearly 100% polylactic acid with a melting point of around 160° C. from the NatureWorks company (4032D). The layer additionally contains stabilisers and neutralisation agents in conventional quantities. The peelable, sealable top layer contains 100% amorphous, sealable raw material from the NatureWorks company (4060D) (component A) and no further biodegradable component B. The thickness of the top layer came to ˜4 μm.

The manufacturing conditions in the individual procedural steps were the same as in example 1, so the film according to example 2 also had the same layer thicknesses as in example 1

TABLE 1

| | | Thickness of the | Total film |
|---|---|---|---|
| | Haze (%) | pealable top layer (μm) | thickness (μm) |
| Ex. 1 | 9 | 3.6 | 50 |
| Ex. 2 | 18 | 5.5 | 50 |
| Ex. 3 | 23 | 3.6 | 50 |
| Comp. ex. 1 | 3 | 3.5 | 50 |

Table 2:

TABLE 2

Seal seam strength N/15 mm at temp.:

| | 80° C. | 90° C. | 100° C. | 110° C. |
|---|---|---|---|---|
| Ex. 1 | — | 3.3 | 3.1 | 3.0 |
| Ex. 2 | — | 0.7 | 2.8 | 3.3 |
| Ex. 3 | — | 1.9 | 2.5 | 2.6 |
| Comp. ex. 1 | — | 5.9 | 6.7 | 6.7 |

The films according to the examples can be excellently peeled on opening of the seal seam without a cohesion fracture or uncontrolled tearing of the film coming about. The film according to the comparative example was de facto destroyed, i.e. torn up, during an attempt to peel the sealing seam.

1-10. (canceled)

11. A multilayer film which comprises a base layer and at least one peelable top layer, wherein the top layer contains 30-80% by weight amorphous polymer A of at least one aliphatic hydroxycarboxylic acid and 20 to 70% by weight biodegradable polymer B different from A, and the top layer has a thickness of at least 3 μm and the peelable top layer in a sealing in the temperature range of 85-120° C. against itself a sealing seam of 1-7 N/15 mm, wherein the sealing is done with a sealing time of 0.5 s and a sealing pressure of 10 N/cm².

12. A multilayer, opaque, biaxially-oriented film which comprises a base layer and at least one top layer wherein the at least one top layer contains amorphous polymer is made up of D and L lactic acid units.

13. The film according to claim 11, wherein amorphous polymer is polylactic acid with 5-18% by weight D lactic acid units.

14. The film according to claim 12, wherein amorphous polymer is polylactic acid with 5-18% by weight D lactic acid units.

15. The film according to claim 11, wherein the polymer B is starch, cellulose or a degradable polyester.

16. The film according to claim 13, wherein the polymer B is starch, cellulose or a degradable polyester.

17. The film according to claim 11, wherein the peelable top layer contains 80 to <100% by weight of the polymer mixture from polymers A and B.

18. The film according to claim 16, wherein the peelable top layer contains 80 to <100% by weight of the polymer mixture from polymers A and B.

19. The film according to claim 11, wherein the thickness of the peelable top layer comes to 3 to 10 μm.

20. The film according to claim 18, wherein the thickness of the peelable top layer comes to 3 to 10 μm.

21. The film according to claim 11, wherein on the side opposite the peelable top layer there is another top layer attached.

22. The film according to claim 20, wherein on the side opposite the peelable top layer there is another top layer attached.

23. The film according to claim 11, wherein the film is transparent.

24. A packaging film which comprises the film as claimed in claim 11.

25. A lid film which comprises the film as claimed in claim 11.
